(19) United States
(12) Patent Application Publication
(10) Pub. No.: US 2011/0101885 A1
(43) Pub. Date: May 5, 2011

(54) LED BACKLIGHT CIRCUIT FOR LCD PANELS

(76) Inventor: Eric YANG, Saratoga, CA (US)

(21) Appl. No.: 12/914,687

(22) Filed: Oct. 28, 2010

Related U.S. Application Data
(60) Provisional application No. 61/257,389, filed on Nov. 2, 2009.

(51) Int. Cl. H05B 37/02

(52) U.S. Cl. 315/294

(57) ABSTRACT

An LED backlight circuit includes a transformer that takes a high voltage from a high voltage bus on a first winding. Current induced on a second winding of the transformer charges an energy storage capacitor. Energy stored in the energy storage capacitor drives a single string of series-connected LEDs to provide backlighting to an LCD panel. The high voltage may be taken directly off an output of a power factor correction circuit.

### CROSS-REFERENCE TO RELATED APPLICATION

This application claims the benefit of U.S. Provisional Application No. 61/257,389, filed on Nov. 2, 2009, which is incorporated herein by reference in its entirety.

### BACKGROUND OF THE INVENTION

1. Field of the Invention

The present invention relates generally to electrical circuits, and more particularly but not exclusively to LED backlight circuits.

2. Description of the Background Art

Liquid Crystal Display (LCD) panels are employed in various display applications including televisions, instrument panels, and computer monitors. An LCD panel may be backlit to improve brightness and general ease of viewing. Popular illumination devices for backlighting include cold cathode fluorescent lamps (CCFLs) and light emitting diodes (LEDs).

FIG. 1 shows an example LCD integrated power supply (LIPS) 100 for an LCD panel. The LIPS 100 includes a power factor correction (PFC) circuit 101, a DC/DC converter 102, a DC/DC converter 103, and a white LED (WLED) backlight circuit 104. The PFC circuit 101 receives AC power to generate 400 VDC on a high voltage bus on node 105. The DC/DC converter 102 receives the 400 VDC from the high voltage bus and converts it to 18 VDC on a node 106 for the DC/DC converter 103 and to 120 VDC on a node 107 for the backlight circuit 104. The DC/DC converter 102 includes a transformer for stepping down the 400 VDC for conversion to 120 VDC provided to the backlight circuit 104 and for conversion to 18 VDC provided to the DC/DC converter 103. The DC/DC converter 103 further converts the 18 VDC to lower voltages (e.g., 12 VDC, 5 VDC, . . . ) for other circuits of the LCD panel. The backlight circuit 104 receives the 120 VDC to power multiple parallel strings of WLEDs to provide backlighting to the LCD panel.

Embodiments of the present invention pertain to a cost-effective LED backlight circuit. For example, embodiments of the present invention allow for an LCD integrated power supply that provides the features of the power supply 100 at a reduced cost.

### SUMMARY

In one embodiment, an LED backlight circuit includes a transformer that takes a high voltage from a high voltage bus on a first winding. Current induced on a second winding of the transformer charges an energy storage capacitor. Energy stored in the energy storage capacitor drives a single string of series-connected LEDs to provide backlighting to an LCD panel. The high voltage may be taken directly off an output of a power factor correction circuit.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of an example LCD integrated power supply for an LCD panel.

FIG. 2 shows a schematic diagram of an LCD integrated power supply in accordance with an embodiment of the present invention.

FIG. 3 shows LEDs connected as parallel strings for backlighting.

FIG. 4 shows LEDs connected as a single string for backlighting in accordance with an embodiment of the present invention.

FIG. 5 shows a schematic diagram of a backlight circuit in accordance with an embodiment of the present invention.

FIG. 6 shows a schematic diagram that illustrates further details of the backlight circuit of FIG. 5 in accordance with an embodiment of the present invention.

FIG. 7 shows a schematic diagram of an LCD integrated power supply in accordance with another embodiment of the present invention.

FIG. 8 schematically shows a backlight circuit in accordance with another embodiment of the present invention.

FIGS. 9 to 17 show waveforms at various nodes of the backlight circuit of FIG. 6 during testing in accordance with another embodiment of the present invention.

The use of the same reference label in different drawings indicates the same or like components.

### DETAILED DESCRIPTION

In the present disclosure, numerous specific details are provided, such as examples of circuits, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

Embodiments of the invention are explained using an LCD integrated power supply with white LED backlighting as an example. One of ordinary skill in the art reading the present disclosure will appreciate that embodiments of the present invention are applicable to LED backlighting applications in general.

FIG. 2 shows a schematic diagram of an LCD integrated power supply 110 in accordance with an embodiment of the present invention. In the example of FIG. 2, the power supply 110 includes a power factor correction (PFC) circuit 115, a DC/DC converter 109, and an LED backlight circuit 112. The PFC circuit 115 receives AC power to generate a high voltage on a high voltage bus on a node 108. In the example of FIG. 2, the power factor correction circuit 115 generates 400 VDC. The PFC circuit 115 is configured to output a high voltage, which is 400 VDC in this example, for improved power factor correction.

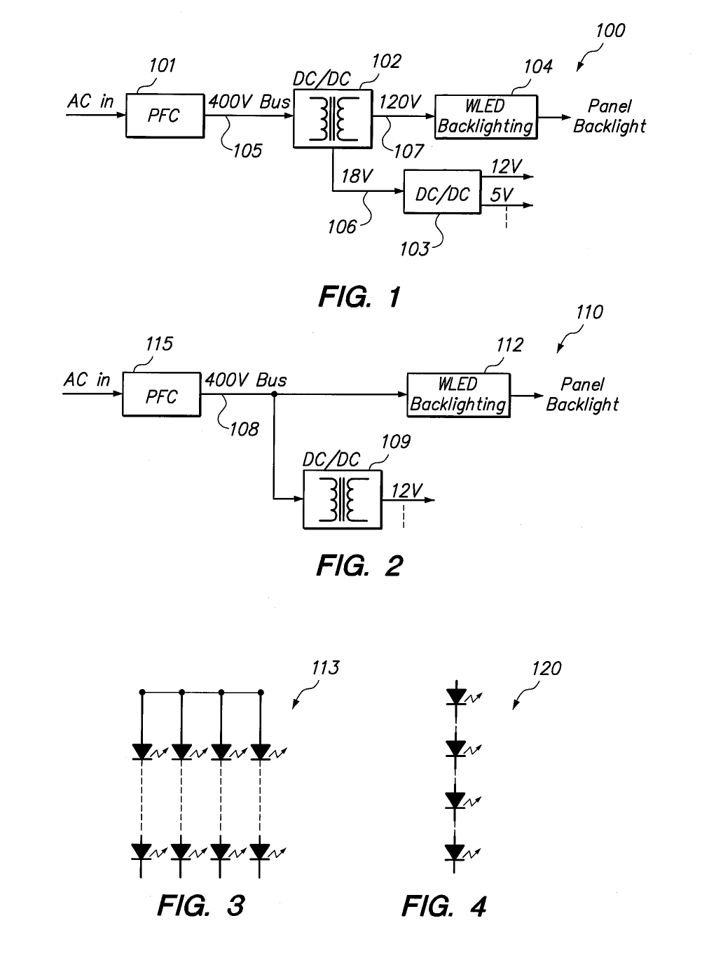

The DC/DC converter 109 receives the high voltage from the high voltage bus and converts the high voltage to one or more lower voltages for use by other circuits of the LCD panel. For example, the DC/DC converter 109 may comprise a flyback converter that converts the 400 VDC from the high voltage bus to 12 VDC, 5 VDC, etc. The DC/DC converter 109 includes a transformer to step down the high voltage to lower voltages. Advantageously, because the DC/DC converter 109 does not provide a voltage output to another DC/DC converter stage, this transformer is relatively small compared to that of the DC/DC converter 102 of FIG. 1.

The LED backlight circuit 112 may comprise an electrical circuit configured to drive and control the illumination of LEDs that provide backlighting to the LCD panel. As shown in FIG. 2, the backlight circuit 112 may take the high voltage directly from the output of the PFC circuit 115. That is, the backlight circuit 112 may employ the high voltage output of the PFC circuit 115 without having to first convert the high voltage to an intermediate lower voltage. This advantageously eliminates the cost of an additional DC/DC converter (e.g., DC/DC converter 102 of FIG. 1) or other circuit stage for converting the high voltage to a lower voltage prior to being provided to the backlight circuit 112. In the example of FIG. 2, the power supply 110 only has two stages, namely the PFC circuit 115 and the backlight circuit 104, from the AC source to the LCD panel.

FIG. 3 shows LEDs connected as parallel strings for backlighting. In the example of FIG. 3, an LED array 113 comprises several strings of LEDs. Each string of LEDs comprises series connected LEDs, and the strings of LEDs are connected in parallel. Several parallel strings of LEDs parallel require lower driving voltage, but electrical current through the strings of LEDs need to be balanced. Balancing may be accomplished using a current source for each string, and adjusting the current sources such that each string of LEDs has the same current through it.

FIG. 4 shows LEDs connected as a single string for backlighting in accordance with an embodiment of the present invention. In the example of FIG. 1, an LED bar 120 comprises a single string of LEDs that are connected in series. Using a single string of LEDs allow for higher driving voltage, which can be up to 500V in some applications, by series-connecting a suitable number of LEDs in the string. The number of LEDs in the string will depend on the high voltage that is directly taken from the high voltage bus. In one embodiment, the LED bar 120 comprises 101 LEDs that are connected in series. Another advantage of the LED bar 120 is that a single string of LEDs does not need current balancing and associated circuits. As will be more apparent below, the backlight circuit 112 has an improved circuit configuration that uses only a single string of LEDs to allow for relatively easy LED drive and control, clean and easy to follow (and debug) schematic, and relatively low implementation cost.

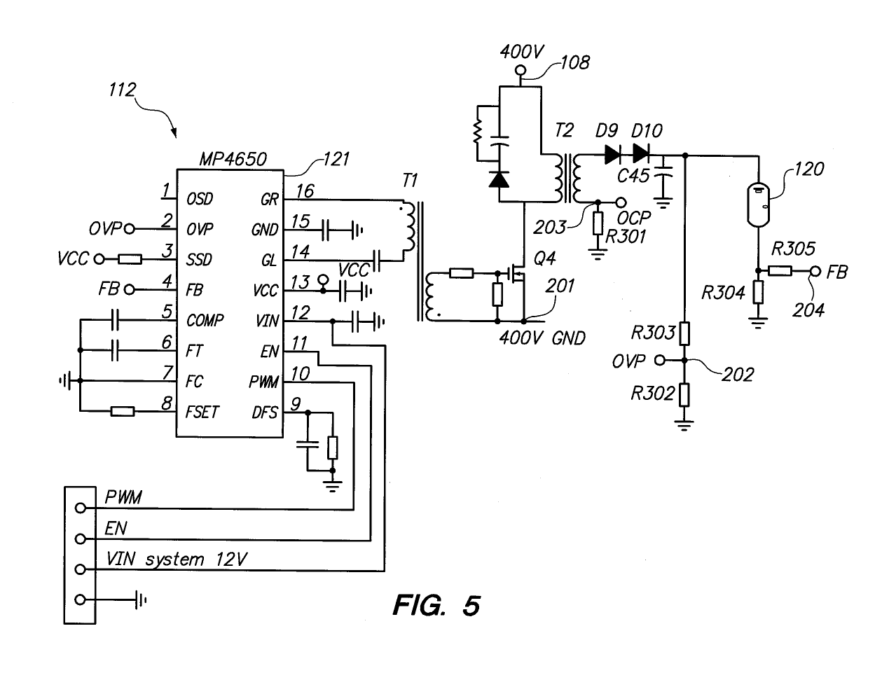

FIG. 5 shows a schematic diagram of the backlight circuit 112 in accordance with an embodiment of the present invention. In the example of FIG. 5, the backlight circuit 112 comprises an LED driver 121, a single LED bar 120, a gate driving isolation transformer T1, and a flyback transformer T2.

In the example of FIG. 5, there is only a single LED bar 120. That is, the LED driver 121 controls only a single string of LEDs that are connected in series. In the example of FIG. 5, the LEDs in the single string of LEDs are the only LEDs coupled to the flyback transformer T2 to provide backlighting to the LCD panel. That is, there are no other LEDs coupled to the flyback transformer T2 that provides backlighting to the LCD panel other than the series connected LEDs in the single string of LEDs. The flyback transformer T2 directly receives the high voltage on the node 108 on the primary winding. The high voltage on the node 108 is taken directly from the output of the power factor correction circuit 115 (see FIG. 2).

The LED driver 121 may comprise an electrical circuit for driving LEDs in backlighting applications. In one embodiment, the LED driver 121 comprises the model MP4650 offline LED driver from Monolithic Power Systems, Inc. One of ordinary skill in the art will appreciate that other LED drivers, either in integrated circuit (IC) or discrete circuitry form, may also be used without detracting from the merits of the present invention.

In the example of FIG. 5, the LED driver 121 is an IC device having a plurality of pins. The LED driver 121 may include an OSD pin for open string detection, an OVP pin for overvoltage protection, an SSD pin for short string detection, an FB pin for LED current feedback input, a COMP pin for feedback compensation, an FT pin for fault timing, an FC pin for control of operating frequency, an FSET pin for setting the operating frequency, a GR pin for driving signal output (which is 180 degrees phase shifted of the GL output), a GND pin for signal ground, a GL pin for driving signal output (which is 180 degrees phase shifted of the GR output), a VCC pin for linear regulator output and bias supply of a gate driver in the device, a VIN pin for supply voltage input, an EN pin for enabling/disabling the device, a PWM pin for burst mode brightness control input, and a DFS pin for setting the burst dimming frequency.

The output of the GR and GL pins are gate driving signals that are 180 degrees phase shifted relative to each other. The gate driving signals control the switching of a drive transistor Q4 by way of the isolation transformer T1. As its name implies, the transformer T1 provides isolation from high voltages that are present on the high voltage side of the transformer T1, which includes the high voltage on the node 108. The LED driver 121 is on one side of the isolation transformer T1, and the drive transistor Q4 is on the high voltage side. The winding on the high voltage side of the isolation transformer T1 uses the high voltage ground on the node 201 for ground reference.

The LED driver 121 controls the switching of the drive transistor Q4 by generating the gate driving signals GR and GL on the primary winding of the isolation transformer T1 to induce current on the secondary winding of the isolation transformer T1. The secondary winding of the isolation transformer T1 is on the high voltage side of the transformer. The LED driver 121 generates the gate driving signals GR and GL to switch ON or switch OFF the drive transistor Q4.

The drive transistor Q4 is configured to couple or decouple the primary winding of the flyback transformer T2 to the high voltage ground on the node 201. When the LED driver 121 switches ON the drive transistor Q4, the drive transistor Q4 is closed to couple the primary winding of the flyback transformer T2 to high voltage ground, thereby allowing current to flow from the high voltage bus on the node 108, through the primary winding of the flyback transformer T2, through the drive transistor Q4, and to the high voltage ground on the node 201. This builds up the energy in the flyback transformer T2. The energy stored in the flyback transformer T2 induces current on the secondary side of the flyback transformer T2, forward biases the diodes D9 and D10, and charges the energy storage capacitor C45. The energy stored in the capacitor C45 provides a voltage that forward biases the series-connected LEDs in the LED bar 120. This results in the LEDs lighting up to provide backlighting to the LCD panel. By controlling the switching of the drive transistor Q4, the LED driver 121 controls the charging of the capacitor C45 and thus the brightness of the LEDs.

When the LED driver 121 switches OFF the drive transistor Q4, the drive transistor Q4 is open and the primary winding of the flyback transformer is decoupled from the high voltage ground. Accordingly, the current flow through the primary winding of the flyback transformer T2 will decay rapidly.

Current through the secondary winding of the flyback transformer T2 may be detected as a voltage drop across a resistor R301. For example, an over current protection (OCP) circuit (not shown) may be coupled to the node 203 to detect the secondary winding current of the flyback transformer T2 and initiate protective measures when the voltage on the node 203 meets or exceeds a threshold level. The voltage across the energy storage capacitor C45 may be detected by way of a voltage divider formed by resistors R302 and R303. In the example of FIG. 5, the voltage across the resistor R302 on node 202 is coupled to the OVP pin of the LED driver 121 to provide over voltage protection. Current through the series-connected LEDs of the single LED bar 120 may be detected by way of the resistors R304 and R305. In the example of FIG. 5, the current through the series-connected LEDs is detected by coupling the node 204 to the FB pin of the LED driver 121. The voltage on the node 204 is indicative of current through the series-connected LEDs, and may be employed by the LED driver 121 for LED current regulation. In the example of FIG. 5, components on the secondary side of the flyback transformer T2, such as the capacitor C45, the resistor R302, and the resistor 304, use the same signal ground as the LED driver 121 for ground reference. The drive transistor Q4 on the primary side of the flyback transistor T2 uses the high voltage ground on node 201 for ground reference.

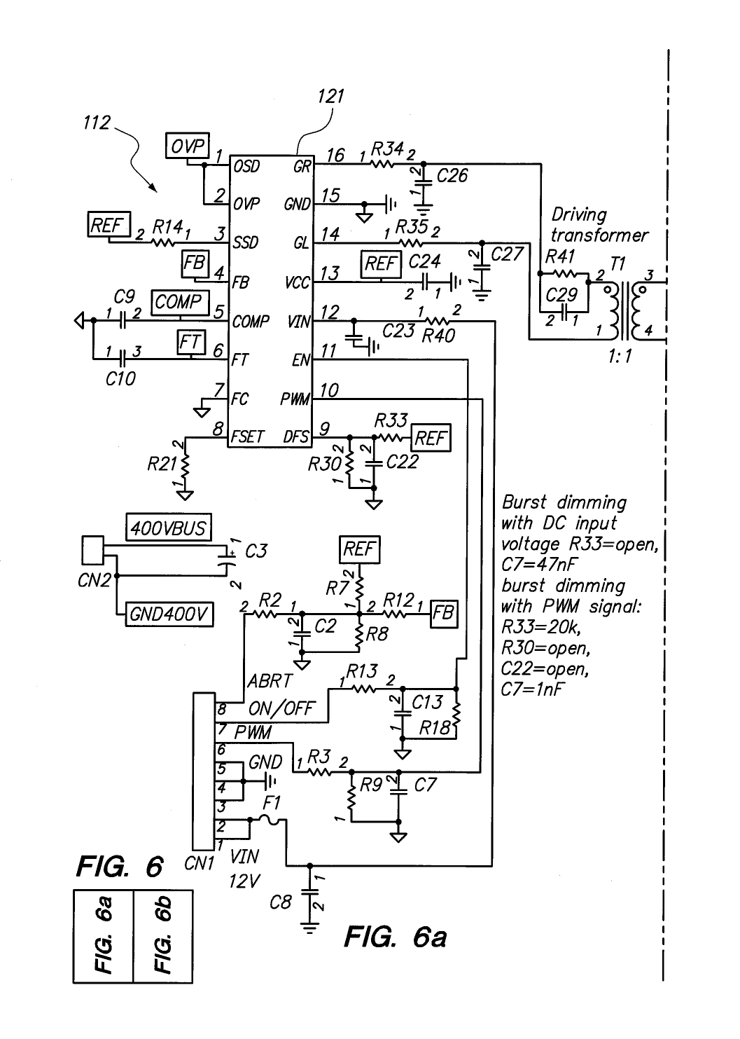

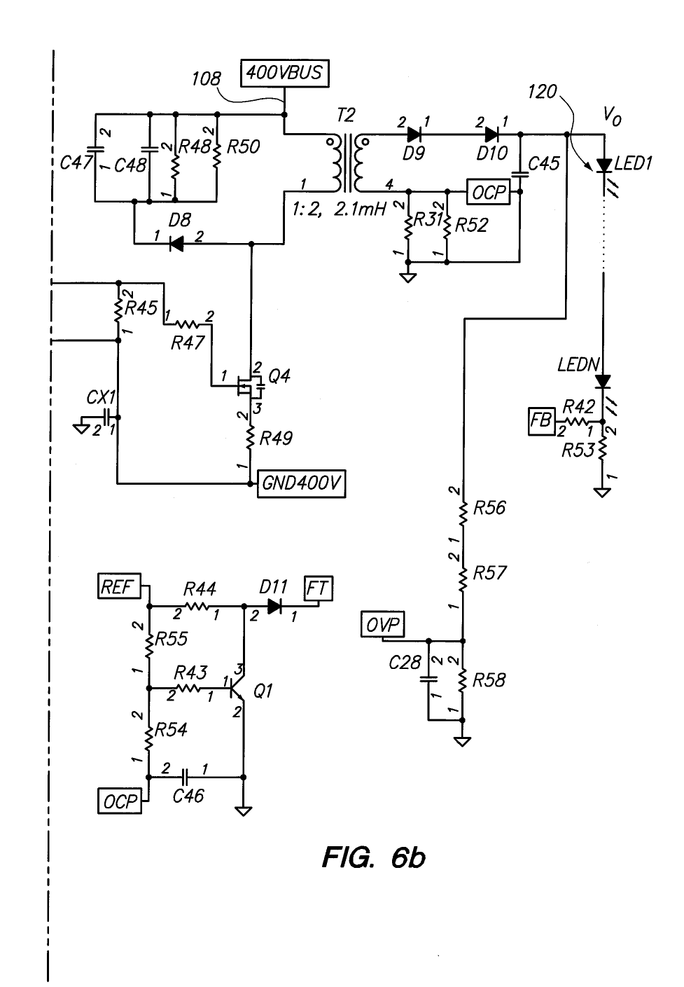

FIG. 6 shows a schematic diagram that illustrates further details of the backlight circuit 112 in accordance with an embodiment of the present invention. FIG. 6 shows particular components and component values for illustration purposes only. It is to be understood that particular components and component values may be varied without detracting from the merits of the present invention.

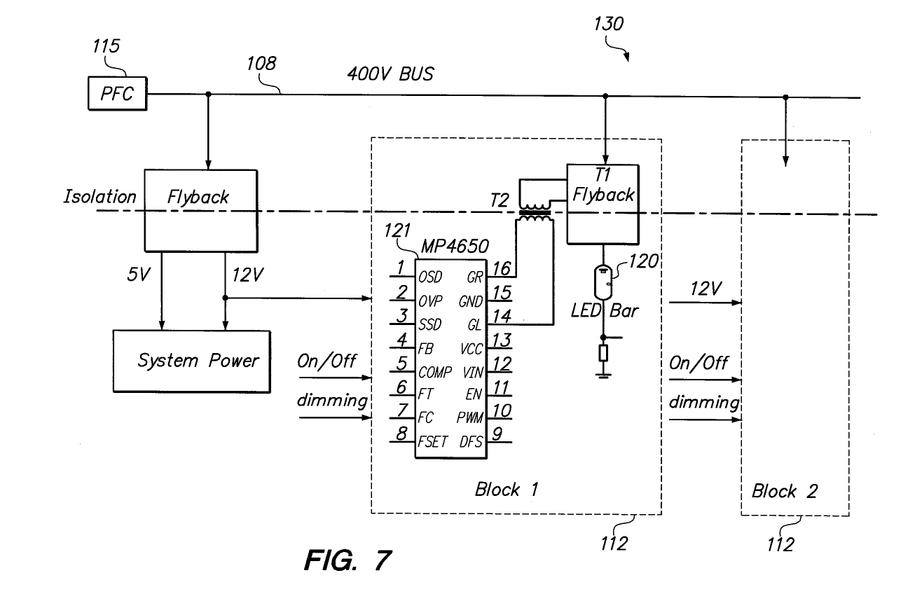

FIG. 7 shows a schematic diagram of an LCD integrated power supply 130 in accordance with another embodiment of the present invention. In the example of FIG. 7, the power supply 130 includes several backlight circuits 112, with each backlight circuit 112 driving only a single LED bar 120. In the example of FIG. 7, each LED driver 121 controls illumination of only a single LED bar 120. Each backlight circuit 112 may provide illumination for a section of an LCD panel, for example. Each backlight circuit 112 may receive high voltage (e.g., 400 VDC) directly from the high voltage bus on the node 108 as output by the power factor correction circuit 115, and drive and control a single string of LEDs as previously described. The backlight circuits 112 may be turned ON/OFF and dimmed independently or together.

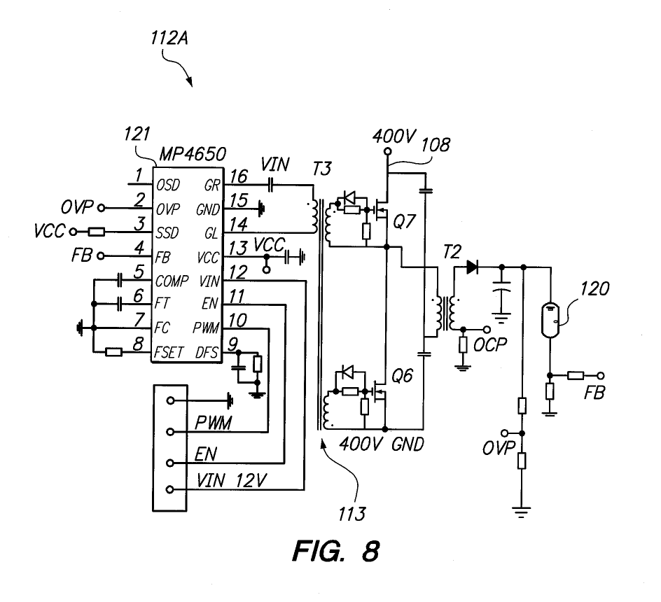

As can be appreciated from the foregoing discussion, the backlight circuit 112 may have alternative configurations without detracting from the merits of the present invention. FIG. 8 schematically shows a backlight circuit 112A in accordance with another embodiment of the present invention. The backlight circuit 112A is similar to the backlight circuit 112 except that the backlight circuit 112A employs a half-bridge configuration in the power stage 113. This is illustrated in FIG. 8 where the transistors Q6 and Q7 on the secondary side of the isolation transformer T3 are configured for half-bridge operation. The backlight circuit 112A otherwise operates the same as the backlight circuit 112.

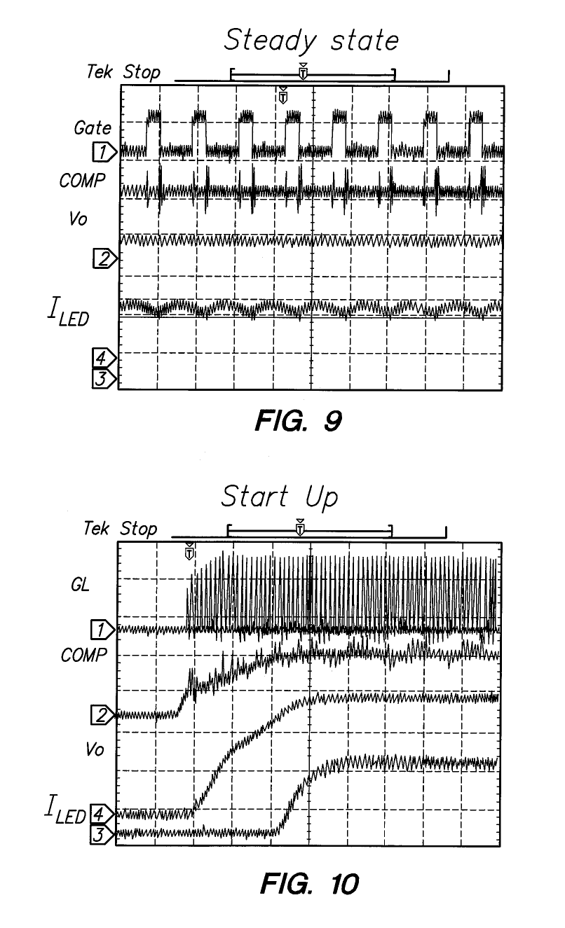

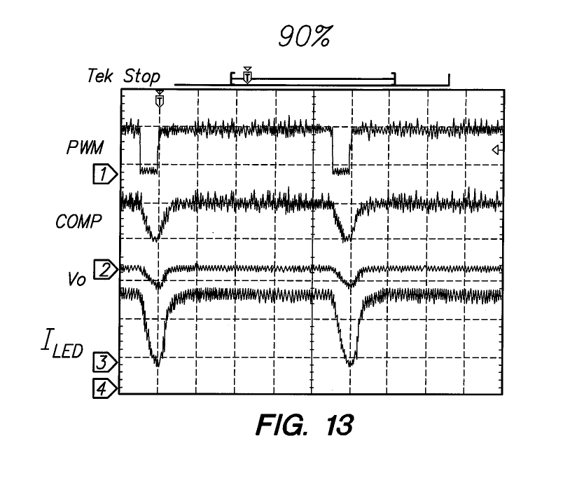

FIGS. 9 to 17 show waveforms at various nodes of the backlight circuit 112 of FIG. 6 during testing. These waveforms were taken using an oscilloscope and are provided herein as examples, not limitations.

FIGS. 9 and 10 show, from top to bottom, waveforms at the gate of the drive transistor Q4 (“Gate” or “GL”), at the COMP pin of the LED driver 121 (“COMP”), of the output voltage (“Vo”; see FIG. 6), and of the current through the string of LEDs (“I_{LED}”).

FIG. 9 shows the aforementioned waveforms at steady state, and FIG. 10 shows the aforementioned waveforms during start up. The waveforms of FIGS. 9 and 10 were taken with VIN=380 VDC and load=60 W (output current I_{O}=180 mA, and 101 LEDs connected in series).

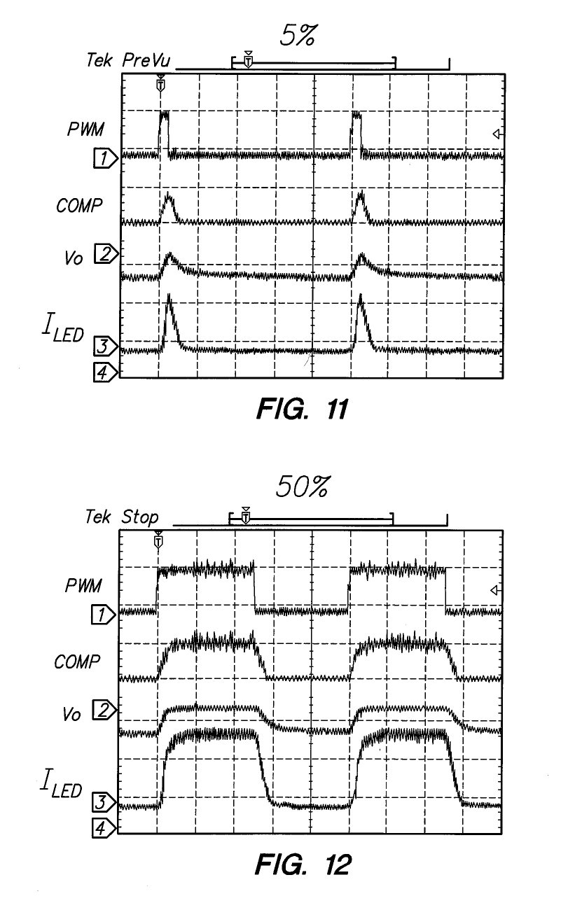

FIGS. 11-13 show, from top to bottom, waveforms at the PWM pin of the LED driver 121 (“PWM”), at the COMP pin of the LED driver 121 (“COMP”), of the output voltage (“Vo”), and of the current through the string of LEDs (“I_{LED}”). FIGS. 11-13 show the aforementioned waveforms at 5%, 50%, and 90% PWM dimming, respectively. The waveforms of FIGS. 11-13 were taken with VIN=380 VDC, load=60 W (output current I_{O}=180 mA, and 101 LEDs connected in series), and 100 Hz PWM dimming.

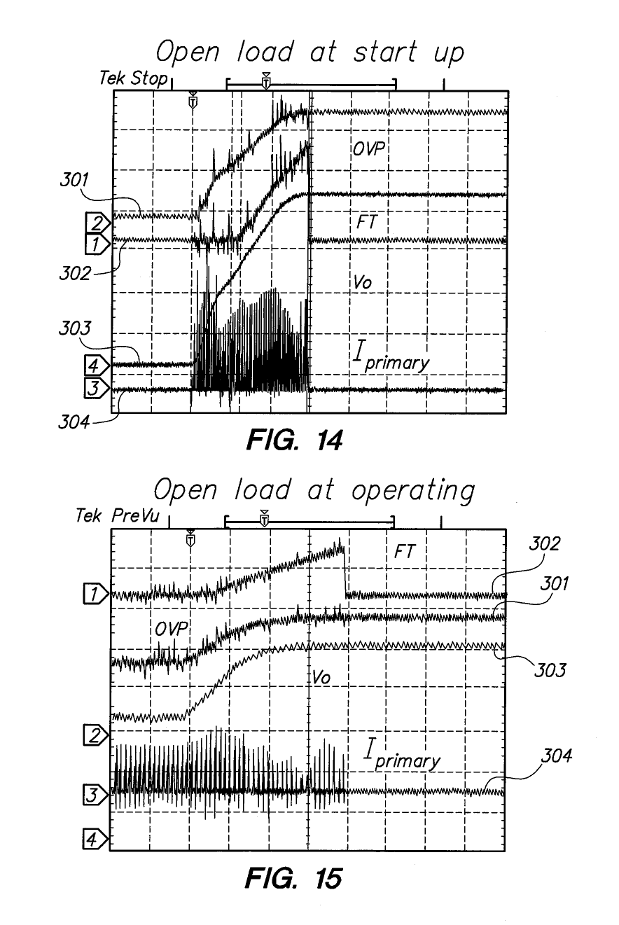

FIGS. 14 and 15 show waveforms at the OVP pin of the LED driver 121 (“OVP”; 301), at the FT pin of the LED driver 121 (“FT”; 302), of the output voltage (“Vo”; 303), and of the current through the primary winding of the flyback transformer T2 (“I_{PRIMARY}” “Iₚᵣᵢ”; 304). FIG. 14 shows the aforementioned waveforms during open load conditions at start up, and FIG. 15 shows the aforementioned waveforms during open load conditions during normal operation.

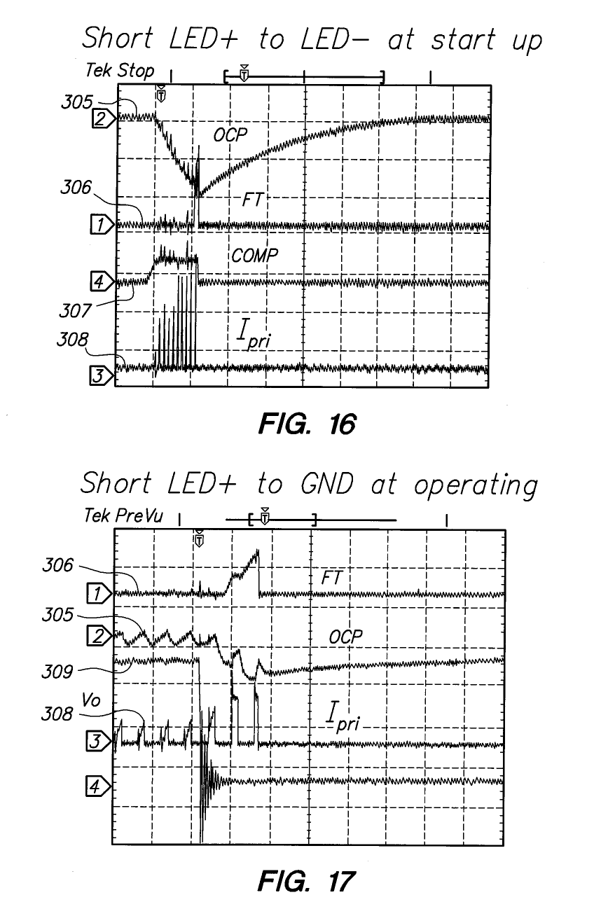

FIGS. 16 and 17 show waveforms at the OCP node of the backlight circuit 112 of FIG. 6 (“OCP”; 305), FT pin of the LED driver 121 (“FT”; 306), and the current through the primary winding of the flyback transformer T2 (“Iₚᵣᵢ”; 308). FIG. 16 also shows the waveform at the COMP pin of the LED driver 121 (“COMP”; 307), and FIG. 17 additionally shows the waveform of the output voltage (“Vo”; 309). FIG. 16 shows the waveforms under shorted LED+ to LED− conditions during start up, and FIG. 17 shows the waveforms at shorted LED+ to signal ground during normal operation.

Improved LED backlight circuits for LCD panels have been disclosed. While specific embodiments of the present invention have been provided, it is to be understood that these embodiments are for illustration purposes and not limiting. Many additional embodiments will be apparent to persons of ordinary skill in the art reading this disclosure.

What is claimed is:

1. An LED backlight circuit comprising:
a high voltage bus providing high voltage;
an isolation transformer having a first winding and a second winding, the first winding of the isolation transformer being coupled to receive gate driving signals;
a flyback transformer having a first winding and a second winding, the high voltage being coupled to the first winding of the flyback transformer;
a drive transistor on the second winding of the isolation transformer, the gate driving signals controlling switching of the driving transistor by inducing current on the second winding, the driving transistor being configured to couple and decouple the first winding of the flyback transformer to a high voltage ground of the high voltage;
an energy storage capacitor configured to be charged by current induced on the second winding of the flyback transformer; and
a single string of LEDs connected in series, the single string of LEDs being forward biased by energy stored in the energy storage capacitor to illuminate the LEDs and provide backlighting to an LCD panel.

2. The backlight circuit of claim 1 wherein the backlight circuit is one of a plurality of backlight circuits providing backlighting to the LCD panel.

3. The backlight circuit of claim 1 wherein the high voltage is 400 VDC.

4. The backlight circuit of claim 1 wherein the high voltage on the high voltage bus is received directly from an output of a power factor correction circuit.

5. The backlight circuit of claim 1 further comprising an LED driver that generates the gate driving signals.

6. The backlight circuit of claim 5 wherein the LED driver is in integrated circuit form.

7. The backlight circuit of claim 1 wherein the single string of LEDs comprises 101 LEDs connected in series.

8. A method of providing backlighting to an LCD panel, the method comprising:
receiving a high voltage in a primary winding of a flyback transformer to induce current in a secondary winding of the flyback transformer;
charging an energy storage capacitor with current induced in the secondary winding of the flyback transformer; and
backlighting an LCD panel by driving a single string of LEDs connected in series with energy stored in the energy storage capacitor, LEDs in the single string of LEDs being only LEDs coupled to the flyback transformer.

9. The method of claim 8 wherein the high voltage in the primary winding of the flyback transformer is received directly from an output of a power factor correction circuit.

10. The method of claim 8 further comprising:
inducing current in a winding of an isolation transformer to control switching of a transistor that is configured to couple/decouple the primary winding of the flyback transformer to high voltage ground of the high voltage.

11. The method of claim 8 wherein the high voltage is 400 VDC.

12. The method of claim 8 wherein the single string of LEDs comprises 101 LEDs connected in series.

13. The method of claim 8 further comprising:
backlighting the LCD panel by driving additional single strings of LEDs connected in series, each of the additional single strings of LEDs being coupled to its own separate flyback transformer.

14. An LED backlight circuit comprising:
a first transformer having a first winding and a second winding, the first winding being coupled directly to a high voltage;
an energy storage capacitor configured to be charged by current induced on the second winding of the first transformer; and
a single string of LEDs connected in series, the single string of LEDs being driven by energy from the energy storage capacitor to illuminate and provide backlighting to an LCD panel, LEDs in the single string of LEDs being only LEDs coupled to the first transformer to provide backlighting to the LCD panel.

15. The backlight circuit of claim 14 further comprising:
a second transformer having a first winding and a second winding; and
a drive transistor on the second winding of the second transformer, switching of the drive transistor being controlled by current induced by gate driving signals on the first winding of the second transformer, the driving transistor being configured to couple and decouple the first winding of the first transformer to a high voltage ground of the high voltage.

16. The backlight circuit of claim 15 further comprising an LED driver that generates the gate driving signals.

17. The backlight circuit of claim 15 wherein the drive transistor is operative with another drive transistor for half-bridge operation.

18. The backlight circuit of claim 14 wherein the backlight circuit is one of a plurality of backlight circuits providing backlighting to the LCD panel.

19. The backlight circuit of claim 14 wherein the high voltage is 400 VDC.

20. The backlight circuit of claim 14 wherein the high voltage is received directly from an output of a power factor correction circuit.
